(19) United States
(12) Patent Application Publication
(10) Pub. No.: US 2026/0182784 A1
(43) Pub. Date: Jul. 2, 2026

(54) SUSPENSION STRUCTURE AND COOKWARE TOOLING

(71) Applicant: Guangdong Nuomi Home Intelligent Technology Co., Ltd, Foshan (CN)

(72) Inventor: Weigang Zheng, Foshan (CN)

(21) Appl. No.: 19/037,217

(22) Filed: Jan. 26, 2025

(30) Foreign Application Priority Data
Dec. 31, 2024 (CN) 202423323558.1

(51) Int. Cl. A47J 43/18; F24C 15/16

(52) U.S. Cl. CPC A47J 43/18; F24C 15/16

(57) ABSTRACT

Disclosed are a suspension structure, which includes a frame assembly including a mounting frame and a fixing mechanism, wherein a mounting groove is arranged on a bottom of the mounting frame, and the fixing mechanism is connected to a top of the mounting frame; and a suspension assembly including a connection mechanism and a suspension member, wherein the connection mechanism is connected to the mounting groove, and the suspension member is connected to the connection mechanism to form a suspension body. The mounting frame is connected to the fixing mechanism, and the mounting groove is arranged on the bottom of the mounting frame. After connecting to the suspension member, the connection mechanism can be assembled in the mounting groove, and the suspension body formed by connecting the two can be used to suspend a to-be-suspension member.

### CROSS-REFERENCE TO RELATED APPLICATION

The present disclosure claims priority to Chinese patent application No. 2024233235581, filed with the Chinese Patent Office on Dec. 31, 2024, the entire contents of which are incorporated herein by reference.

### TECHNICAL FIELD

The present disclosure relates to the technical field of household appliances, and specifically to a suspension structure and a cookware tooling.

### BACKGROUND ART

With the improvement of living standards of people, the requirements for furniture and living environments are becoming increasingly higher. In daily life, the use of kitchens is indispensable, and the storage of the kitchen is also particularly important.

Currently, in order to facilitate the storage of cookware, the pot pull-out baskets are widely used in most kitchen cabinets. However, existing pot pull-out baskets mainly store pots in a flat position, which takes up a larger space and is not good for draining water.

### SUMMARY

The objective of the embodiments of the present disclosure is to provide a suspension structure and a cookware tooling, which are stored in a suspension method, occupy a small space, and are not easy to collect dust, dirt, and water stains.

In a first aspect, the embodiments of the present disclosure provide a suspension structure, including: a frame assembly, including a mounting frame and a fixing mechanism, wherein a mounting groove is arranged on a bottom of the mounting frame, and the fixing mechanism is connected to a top of the mounting frame; and a suspension assembly, including a connection mechanism and a suspension member, wherein the connection mechanism is connected to the mounting groove, and the suspension member is connected to the connection mechanism to form a suspension body.

In the process of the above realization, the mounting frame is connected to the fixing mechanism, and the mounting groove is arranged on the bottom of the mounting frame. After connecting to the suspension member, the connection mechanism can be assembled in the mounting groove, and the suspension body formed by connecting the two can be used to suspend a to-be-suspension member. It occupies a smaller space and is not easy to collect dirt and dust at the same time, where the water can drip from top to bottom to avoid water stains.

In some embodiments, the connection mechanism includes a first connector and a second connector, wherein the first connector is connected to the mounting groove; the second connector is connected to one side of the first connector away from the mounting frame; and one side of the second connector is connected to the suspension member.

In the process of the above realization, after the first connector is connected to the second connector, it can be adapted to the mounting groove, so that the to-be-suspension member can be vertically placed when the to-be-suspension member is suspended on the suspension body formed by the second connector and the suspension member. It occupies a smaller space is not easy to collect the dirt and dust at the same time, and the water can also drip from top to bottom to avoid water stains.

In some embodiments, the connection mechanism further includes a first protrusion, wherein the first protrusion is connected to one side of the first connector away from the second connector so that a first gap is formed between the first connector and the mounting groove.

In the process of the above realization, the first connector is provided with the first protrusion, so that the first gap can be formed between the first connector and the mounting groove when the first connector is assembled in the mounting groove, which can reduce the friction generated by the movement during the assembly, and at the same time provide a certain preloading force.

In some embodiments, the connection mechanism further includes a second protrusion, wherein the second protrusion is connected to a periphery of the first connector so that a second gap is formed between the first connector and the mounting groove.

In the process of the above realization, the periphery of the first connector is provided with the second protrusion, so that the second gap can be formed between the first connector and the mounting groove when the first connector is assembled in the mounting groove, which can reduce the friction generated by the movement during the assembly, and at the same time provide a certain preloading force.

In some embodiments, the mounting frame includes a first frame and a second frame, wherein a first extension member and a second extension member extend from a bottom of the first frame in a direction close to the suspension assembly; the first extension member and the second extension member are arranged at intervals; the connection mechanism is configured between the first extension member and the second extension member; the connection mechanism is connected to the first extension member and the second extension member respectively; and the second frame is connected to an inner cavity of the first frame.

In the process of the above realization, after the first extension member and the second extension member of the first frame are arranged at intervals, the suspension assembly can be arranged between the first extension member and the second extension member in a threading manner, and contacts with the first extension member and the second extension member respectively, so that the to-be-suspension member can be suspended and the space occupied by the to-be-suspension member is reduced. The second frame is connected to the interior of the first frame, so that the fixing mechanism can be hidden, and the whole is more beautiful and compact.

In some embodiments, the mounting frame further includes a head sealing mechanism, and the head sealing mechanism is connected to one side of the first frame and the second frame, so as to seal one side of the first frame, which can limit the position of the suspension assembly on one side of the first frame close to the head sealing mechanism, thereby avoiding the suspension assembly slipping off from this side and ensuring the safety.

In some embodiments, the fixing mechanism includes fixing plates and a guide rail, wherein at least a partial structure of the fixing plates is configured between the first frame and the second frame, and the guide rail is configured between the fixing plates and the second frame.

In the above-realized process, the fixing plate is connected to the guide rail, and the guide rail can play a guiding role for the second frame; at the same time, both the fixing plate and the guide rail can be located between the first frame and the second frame, so that at least partial structure of the fixing plate and the guide rail can be hidden to ensure the aesthetics and compactness of the whole structure. At the same time, the fixing plate can be used as a fixed part for fixing the whole structure to the position that needs to be mounted.

In some embodiments, the fixing mechanism further includes a supporting member, and the supporting member is connected between two fixing plates. It can realize the position limitation between the two fixing plates, so as to avoid the fixing plates from tilting to the left and right and being unstable during use, and at the same time, it can also ensure a distance between the two fixing plates and improve the structure strength of the fixing plates.

In some embodiments, the frame assembly further includes a cover plate, wherein the cover plate is provided with a bent body. The cover plate is configured at a bottom of the fixing mechanism, and the bent body bends relative to the fixing mechanism and extends to an upper end of the fixing mechanism.

In the above realization process, the cover plate is provided with the bent body, and the bent body extends to the upper end of the fixing mechanism, which can realize the adaptation between the cover plate and the fixing mechanism. Therefore, the partial structure of the fixing mechanism can be covered, which is beneficial to ensure the beauty and cleanness of the whole structure.

In some embodiments, one end of the bent body is provided with a first adaption part, and an upper end of the fixing mechanism is provided with a second adaption part, so that the first adaption part is adapted to the second adaption part after the cover plate is assembled to the fixing mechanism.

In the process of the above realization, the bent body is provided with the first adaption part, and the fixing mechanism is provided with the second adaption part, so that the cover plate slides relative to the fixing mechanism. After the cover plate is assembled to the fixing mechanism, the position limitation between the cover plate and the fixing mechanism can be realized by the adaption of the first adaption part and the second adaption part, which prevents the cover plate from directly falling off from the fixing mechanism. This is beneficial for covering the partial structure of the fixing mechanism to ensure the aesthetics and cleanness of the whole structure.

In some embodiments, the frame assembly further includes a sealing-cover assembly, wherein the sealing-cover assembly is configured on one side of the cover plate away from the first adaption part. The sealing-cover assembly includes a first sealing cover and a second sealing cover, wherein at least the partial structure of the first sealing cover is configured in an inner cavity of the cover plate, the partial structure is connected to the fixing mechanism, and the second sealing cover is connected to the first frame.

In the process of the above realization, the first sealing cover is adapted to the cover plate, and the first sealing cover is connected to the fixing mechanism, so that the cover plate can be sealed and limited when the first adaption part is adapted to the second adaption part and the first sealing cover is connected to the fixing mechanism. This ensures that the cover plate will not fall off from the fixing mechanism after being assembled to the fixing mechanism. At the same time, the second sealing cover is connected to the first frame, so that the opposite sides of the suspension assembly can be limited through the cooperation with the head sealing mechanism, thereby preventing the suspension assembly from slipping off from the first frame and ensuring the safety.

In some embodiments, the suspension structure further includes a mounting assembly, and the mounting assembly is connected to an upper end of the frame assembly, so that the mounting assembly can be additionally mounted to the upper end of the frame assembly according to the actual assembly situation, so as to improve the applicability of the product.

In a second aspect, the present disclosure also provides a cookware tooling, including: a cabinet, provided with an accommodation cavity; and a suspension structure as described in any one of the foregoing, wherein the suspension structure is connected to the accommodation cavity.

Since the cookware tooling provided by the second aspect includes the suspension structure, the cookware tooling has all the technical effects of the suspension structure, which will not be repeated herein.

Other features and advantages of the present disclosure will be described in the subsequent specification, or, partial features and advantages can be deduced or determined from the specification without doubt or can be known by performing techniques of the present disclosure as described above.

In order to make the above objectives, features, and advantages of the present disclosure more obvious and easy to understand, the following is a detailed description of preferred embodiments in conjunction with the drawings.

### BRIEF DESCRIPTION OF DRAWINGS

In order to more clearly illustrate the technical solutions in the embodiments of the present disclosure, the drawings to be used in the embodiments of the present disclosure will be briefly introduced below. It should be understood that the following drawings only show certain embodiments of the present disclosure, and therefore should not be regarded as a limitation of the scope. For a person of ordinary skill in the art, other relevant drawings can be obtained according to these drawings without inventive efforts.

FIG. 1 shows a schematic structure diagram of a suspension structure provided by the embodiments of the present disclosure;

FIG. 2 is another schematic structure diagram of a suspension structure provided by the embodiments of the present disclosure;

FIG. 3 shows an explosion schematic diagram of FIG. 1;

FIG. 4 shows a sectional diagram of a suspension structure provided by the embodiments of the present disclosure;

FIG. 5 shows a schematic structure diagram of a connection mechanism of a suspension structure being adapted to a mounting frame provided by the embodiments of the present disclosure;

FIG. 6 shows a schematic structure diagram of a cover plate of a suspension structure being adapted to a fixing mechanism provided by the embodiments of the present disclosure;

FIG. 7 shows a schematic structure diagram of a suspension assembly of a suspension structure provided by the embodiments of the present disclosure; and

FIG. 8 shows a schematic structure diagram of a cookware tooling provided by the embodiments of the present disclosure.

### REFERENCE NUMBERS

10, frame assembly; 101, first frame; 1011, first extension member; 1012, second extension member; 1013, mounting groove; 1014, first limiting groove; 102, second frame; 103, fixing plate; 1031, second adaption part; 1032, second limiting groove; 104, guide rail; 105, supporting member; 106, head sealing mechanism; 1061, first limiting block; 107, cover plate; 1071, first adaption part; 108, first sealing cover; 1081, second limiting block; 109, second sealing cover; 1091, cover handle; 1092, decorative cover; 20, suspension assembly; 201, first connector; 202, second connector; 203, suspension member; 204, first protrusion; 205, second protrusion; 30, mounting assembly; 301, rear buckle; 302, welding member; 303, fixing member; and 40, cabinet.

### DETAILED DESCRIPTION OF EMBODIMENTS

The technical solutions in the embodiments of the present disclosure will be clearly and completely described below in conjunction with the drawings in the embodiments of the present disclosure. It is clear that the embodiments described are only partial embodiments of the present disclosure and not all of the embodiments. The assembly in embodiments of the present disclosure generally described and shown in the drawings herein can be arranged and designed in various configurations. Therefore, the following detailed description of the embodiments of the present disclosure arranged in the drawings is not intended to limit the scope of the present disclosure for which protection is claimed, but only represents selected embodiments of the present disclosure. Based on the embodiments in the present disclosure, all other embodiments obtained by a person skilled in the art without inventive efforts, shall all fall within the scope of protection of the present disclosure.

In the present disclosure, orientations or positional relationships indicated by the terms “up”, “down”, “left”, “right”, “front”, “back”, “top”, “bottom”, “inside”, “outside”, “center”, “vertical”, “horizontal”, “transverse”, “longitudinal”, etc., are based on the orientation or position relationship shown in the drawings. These terms are used primarily to better describe the present disclosure and the embodiments and are not intended to limit that the indicated device, component, or composition must have a particular orientation, or be constructed and operated in a particular orientation.

Moreover, some of the above terms can be used to indicate other meanings in addition to the orientations or positional relationships, for example, the term “on” can also be used to indicate a certain dependency relationship or a connection relationship in some cases. For a person of ordinary skill in the art, the specific meaning of these terms in the present disclosure can be understood according to specific situations.

Additionally, the terms “mount”, “arrange”, “provide”, “connect”, and “link” should be understood broadly. For example, it can be a fixed connection, a detachable connection, or an integral construction; it can be a mechanical connection or a point connection; and it can be a direct connection, an indirect connection through an intermediate medium, or a communication inside two devices, components, and compositions. For a person of ordinary skill in the art, the specific meaning of the above terms in the present disclosure can be understood according to specific situations.

Additionally, the terms “first”, “second”, etc. are used primarily to distinguish between different devices, components, or compositions (wherein the specific types and constructions can be the same or different), and are not intended to indicate or imply the relative importance and the amounts of the indicated devices, components, or compositions. Unless otherwise indicated, “plurality” means two or more.

### Embodiments

In the present disclosure, the suspension structure includes a frame assembly and a suspension assembly 20, wherein the frame assembly is configured to be fixed at a designated area, such as a cabinet 40, and the suspension assembly 20 is slidably connected to the bottom of the frame assembly. The to-be-suspension member 203 can be suspended by the suspension assembly 20, wherein the to-be-suspension member 203 includes, but is not limited to, the cookware.

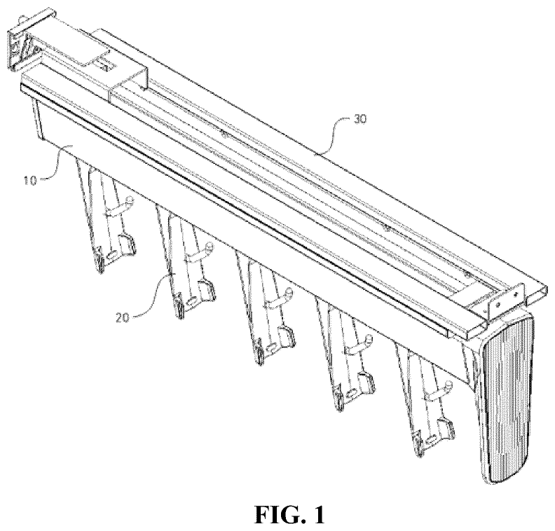

Specifically, as shown in FIG. 1-FIG. 7, in a first aspect, the embodiment of the present disclosure provides a suspension structure, which includes: a frame assembly 10 including a mounting frame and a fixing mechanism, wherein a mounting groove 1013 is arranged on a bottom of the mounting frame, and the fixing mechanism is connected to the top of the mounting frame; and a suspension assembly 20 including a connection mechanism and a suspension member 203, wherein the connection mechanism is connected to the mounting groove 1013, and the suspension member 203 is connected to the connection mechanism to form a suspension body.

Exemplarily, the mounting frame is distributed along a first direction, wherein the first direction includes but is not limited to the left-right direction. The fixing mechanism is connected to an inside frame of the mounting frame; the fixing mechanism can be configured to be distributed along the first direction; and the partial structure of the fixing mechanism is exposed to the mounting frame. The suspension assembly 20 is configured to distribute along a second direction, wherein the second direction includes but is not limited to the up-down direction. A plurality of suspension assemblies 20 can be provided according to the actual needs, wherein the plurality of the suspension assemblies 20 are assembled in the mounting groove 1013, and each of the suspension assemblies 20 can be configured to suspend at least one of the to-be-suspension members 203.

In the process of the above realization, the mounting frame is connected to the fixing mechanism, and the mounting groove 1013 is arranged on the bottom of the mounting frame. After connecting to the suspension member 203, the connection mechanism can be assembled in the mounting groove 1013, and the suspension body formed by connecting the two can be configured to suspend the to-be-suspension member 203. It occupies a smaller space and is not easy to collect dirt and dust at the same time, where the water can drip from top to bottom to avoid storing water stains.

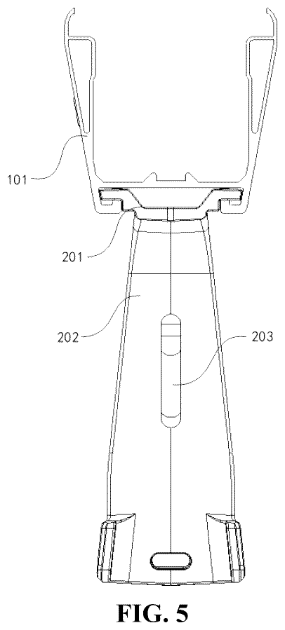

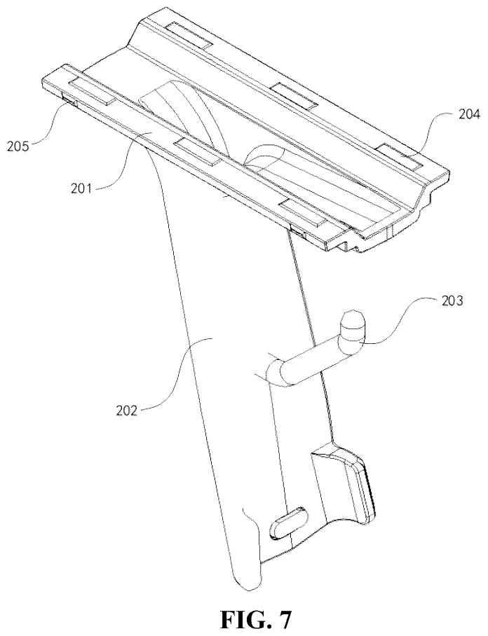

As shown in FIG. 5 and FIG. 7, the connection mechanism includes a first connector 201 and a second connector 202, wherein the first connector 201 is connected to the mounting groove 1013; the second connector 202 is connected to one side of the first connector 201 away from the mounting frame; and one side of the second connector 202 is connected to the suspension member 203.

Exemplarily, the first connector 201 is arranged above the second connector 202; the connection method between the first connector 201 and the second connector 202 can be integrally molded, e.g., the first connector 201 and the second connector 202 are made by an adhesive coating process; both the first connector 201 and the second connector 202 can be made of PA material; the suspension member 203 includes, but is not limited to, iron hooks; and one end of the suspension member 203 away from the second connector 202 can be arranged in a circular shape. Of course, in other embodiments, the connection method between the first connector 201 and the second connector 202 can be welding. The structure of the first connector 201 adapted to the mounting groove 1013 can be arranged as a flat type or a bent type.

In the process of the above realization, after the first connector 201 is connected to the second connector 202, it can be adapted to the mounting groove 1013, so that the to-be-suspension member 203 can be vertically placed when the to-be-suspension member 203 is suspended on the suspension body formed by the second connector 202 and the suspension member 203. It occupies a smaller space and is not easy to collect dirt and dust at the same time, where the water can drip from top to bottom to avoid storing water stains.

Referring to FIG. 7, the connection mechanism further includes a first protrusion 204, wherein the first protrusion 204 is connected to one side of the first connector 201 away from the second connector 202 so that a first gap is formed between the first connector 201 and the mounting groove 1013. Exemplarily, the shape of the first protrusion 204 can be arranged as a square, a trapezoid, a cylindrical shape, a whole plane, etc. The first protrusion 204 is arranged at the upper end of the first connector 201; the connection method between the first protrusion 204 and the first connector 201 includes, but is not limited to, the adhesive coating process; a plurality of the first protrusion 204 are arranged at intervals along a length direction (e.g., the left-right direction) of the first connector 201; and two rows of the first protrusion 204 are arranged at intervals in a width direction (e.g., the front-back direction) of the first connector 201.

In the process of the above realization, the first connector 201 is provided with the first protrusions 204, so that the first gap can be formed between the first connector 201 and the mounting groove 1013 when the first connector 201 is assembled in the mounting groove 1013, which can reduce the friction generated by the movement during the assembly and at the same time provide a certain preloading force.

Referring to FIG. 7, the connection mechanism further includes a second protrusion 205, wherein the second protrusion 205 is connected to a periphery of the first connector 201 so that a second gap is formed between the first connector 201 and the mounting groove 1013. Exemplarily, the second protrusion 205 is arranged on a side wall of the first connector 201 and located on both front and back sides of the first connector 201, wherein the shape of the second protrusion 205 can be consistent with or different from that of the first protrusion 204. At the same time, a plurality of second protrusions 205 can be provided, and the plurality of second protrusions 205 are arranged at intervals.

In the process of the above realization, the periphery of the first connector 201 is provided with the second protrusion 205, so that the second gap can be formed between the first connector 201 and the mounting groove 1013 when the first connector 201 is assembled in the mounting groove 1013, which can reduce the friction generated by the movement during the assembly and at the same time provide a certain preloading force.

As shown in FIG. 1-FIG. 4, the mounting frame includes a first frame 101 and a second frame 102, wherein a first extension member 1011 and a second extension member 1012 extend from the bottom of the first frame 101 in a direction close to the suspension assembly 20; the first extension member 1011 and the second extension member 1012 are arranged at intervals; the connection mechanism is configured between the first extension member 1011 and the second extension member 1012; the connection mechanism is connected to the first extension member 1011 and the second extension member 1012; and the second frame 102 is connected to an inner cavity of the first frame 101.

Exemplarily, the first frame 101 is an outside frame, and the second frame 102 is an inside frame. The middle part of the first frame 101 can be provided as a groove, and the middle part of the second frame 102 is provided with a sliding block, wherein the sliding block is adapted to the groove, so that the position of the first frame 101 and the second frame 102 can be limited. Meanwhile, in order to ensure the stability between the two, the first frame 101 and the second frame 102 can be tightened by screws after they are assembled.

It can be understood that the first extension member 1011 and the second extension member 1012 can be symmetrical components, and both the first extension member 1011 and the second extension member 1012 can correspond to at least one row of the first protrusions 204, so as to ensure that the connection mechanism is horizontal when the connection mechanism is assembled in the mounting groove 1013.

In the process of the above realization, after the first extension member 1011 and the second extension member 1012 of the first frame 101 are arranged at intervals, the suspension assembly 20 can arranged between the first extension member 1011 and the second extension member 1012 in a threading manner and contacts with the first extension member 1011 and the second extension member 1012 respectively, so that the to-be-suspension member 203 can be suspended and the space occupied by the to-be-suspension member 203 is reduced. The second frame 102 is connected to the inside of the first frame 101, so that the fixing mechanism can be hidden, and the whole is more beautiful and compact.

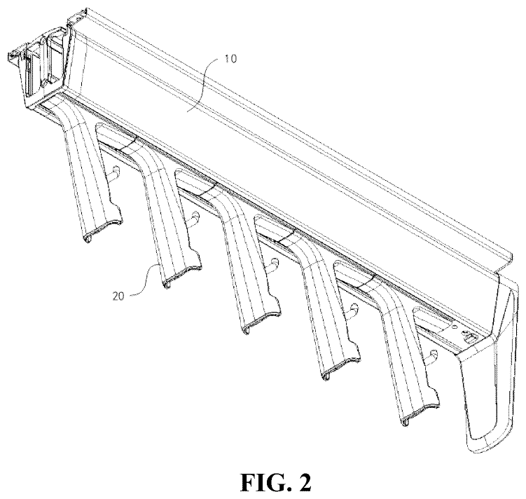

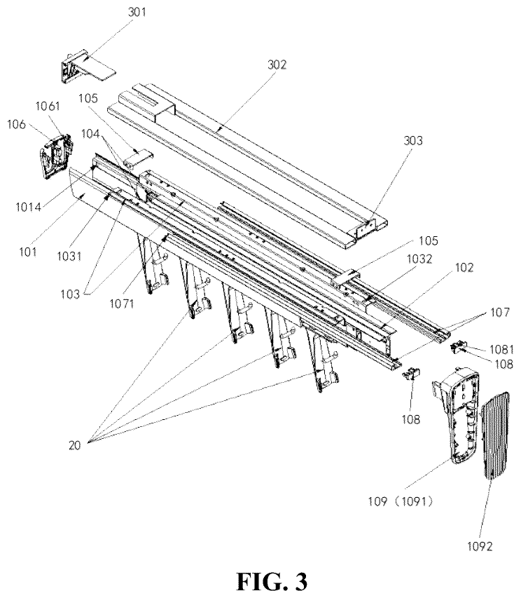

As shown in FIG. 2 and FIG. 3, the mounting frame further includes a head sealing mechanism 106, and the head sealing mechanism 106 is connected to one side of the first frame 101 and the second frame 102, wherein the head sealing mechanism 106 is made of a material including, but not limited to PA material. In order to realize the fixation of the head sealing mechanism 106 with the first frame 101, the head sealing mechanism 106 is provided with a first limiting block 1061; the first frame 101 is provided with a first limiting groove 1014; and the first limiting block 1061 is adapted to the first limiting groove 1014. Of course, in other embodiments, it is also possible to directly fix the two by screws, so as to seal one side of the first frame 101, which can limit the position of the suspension assembly 20 on one side of the first frame 101 close to the head sealing mechanism 106, thereby avoiding the suspension assembly 20 slipping off from this side and ensuring the safety.

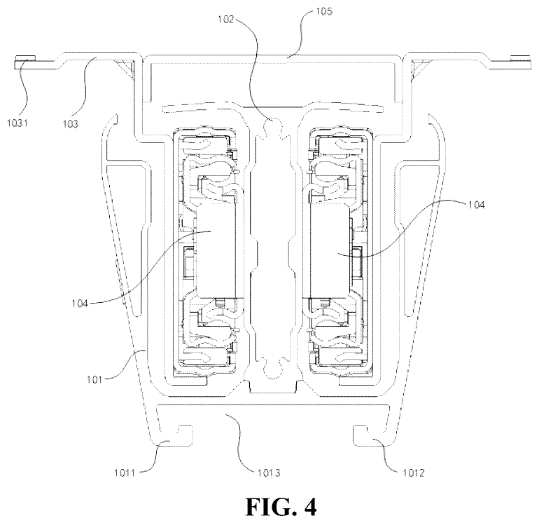

As shown in FIG. 3 and FIG. 4, the fixing mechanism includes fixing plates 103 and a guide rail 104, wherein at least partial structure of the fixing plates 103 is configured between the first frame 101 and the second frame 102, and the guide rail 104 is configured between the fixing plates 103 and the second frame 102.

Exemplarily, upper ends of the fixing plates 103 extend to the outside of the first frame 101 for exposure, wherein two fixing plates 103 are provided; the guide rail 104 is fixed on each of the fixing plates 103; and the guide rail 104 is configured between the two fixing plates 103. The second frame 102 is located between the two guide rails 104 and extends to the bottom of the first frame 101 (i.e., adapted to the sliding block via the groove), and then is fastened by screws.

In the above-realized process, the fixing plate 103 is connected to the guide rail 104, and the guide rail 104 can play a guiding role for the second frame 102. At the same time, both the fixing plate 103 and the guide rail 104 can be located between the first frame 101 and the second frame 102, so that at least the partial structure of the fixing plate 103 and the guide rail 104 can be hidden to ensure the aesthetics and compactness of the whole structure. The fixing plate 103 can be a fixed part configured for fixing the whole structure to the position that needs to be mounted.

As shown in FIG. 3 and FIG. 4, the fixing mechanism further includes a supporting member 105; the supporting member 105 includes, but is not limited to, a u-shape; and the supporting member 105 is connected between the two fixing plates 103, e.g., the supporting member 105 is fixed to the fixing plates 103 by screws. It can realize the position limitation between the two fixing plates 103, so as to avoid the fixing plates 103 from tilting to the left and right and being unstable during use, and at the same time, it can also ensure a distance between the two fixing plates 103 and improve the structure strength of the fixing plates 103.

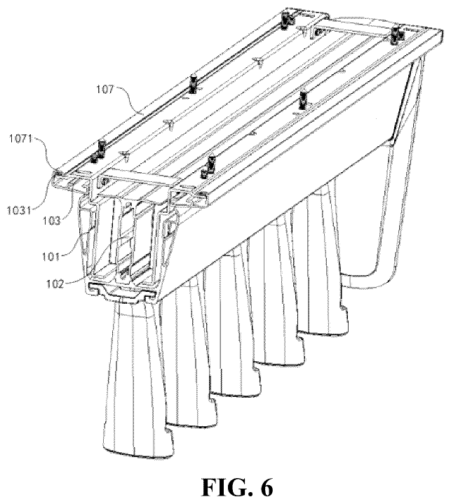

As shown in FIG. 6, the frame assembly 10 further includes a cover plate 107, wherein the cover plate 107 is provided with a bent body; the cover plate 107 is configured at a bottom of the fixing mechanism; and the bent body bends relative to the fixing mechanism and extends to an upper end of the fixing mechanism. Two cover plates 107 are provided, and the cover plate 107 is adapted to the fixing plate 103 of each fixing mechanism.

In the above realization process, the cover plate 107 is provided with the bent body, and the bent body extends to the upper end of the fixing mechanism, which can realize the adaptation between the cover plate 107 and the fixing mechanism, so as to cover the partial structure of the fixing mechanism, which is beneficial to ensure the beauty and cleanness of the whole structure.

As shown in FIG. 6, one end of the bent body is provided with the first adaption part 1071, wherein the first adaption part 1071 can be in the form of a groove, and the upper end of the fixing mechanism is provided with a second adaption part 1031, wherein the second adaption part 1031 can be in the form of a bump, so that the first adaption part 1071 is adapted to the second adaption part 1031 after the cover plate 107 is assembled to the fixing mechanism.

In the process of the above realization, the bent body is provided with the first adaption part 1071, and the fixing mechanism is provided with the second adaption part 1031, so that the cover plate 107 slides relative to the fixing mechanism. After the cover plate is assembled to the fixing mechanism, the position limitation between the cover plate 107 and the fixing mechanism can be realized by the adaption of the first adaption part 1071 and the second adaption part 1031, which prevents the cover plate 107 from directly falling off from the fixing mechanism, which is beneficial for covering the partial structure of the fixing mechanism to ensure the aesthetics and cleanness of the whole structure.

As shown in FIG. 3, the frame assembly 10 further includes a sealing-cover assembly, wherein the sealing-cover assembly is configured on one side of the cover plate 107 away from the first adaption part 1071, and the sealing-cover assembly includes a first sealing cover 108 and a second sealing cover 109, wherein at least partial structure of the first sealing cover 108 is configured in an inner cavity of the cover plate 107, and the partial structure is connected to the fixing mechanism. For example, the first sealing cover 108 is provided with a second limiting block 1081; the fixing plate 103 is provided with a second limiting groove 1032. The second limiting block 1081 is adapted to the second limiting groove 1032. The second sealing cover 109 and the first frame are connected, and they can also be connected by a limiting groove and a limiting block. Moreover, for facilitating the mold release, the second sealing cover 109 includes a cover handle 1091 and a decorative cover 1092, and the decorative cover 1092 is assembled on one side of the sealing cover away from the first frame.

In the process of the above realization, the first sealing cover 108 is adapted to the cover plate 107, and the first sealing cover 108 is connected to the fixing mechanism, so that the cover plate 107 can be sealed and limited when the first adaption part 1071 is adapted to the second adaption part 1031 and the first sealing cover 108 is connected to the fixing mechanism, so as to ensure that the cover plate 107 will not fall off from the fixing mechanism after assembled to the fixing mechanism. At the same time, the second sealing cover 109 is connected to the first frame, so that the opposite sides of the suspension assembly 20 can be limited through the cooperation with the head sealing mechanism 106, thereby avoiding the suspension assembly 20 slipping off from the first frame and ensuring the safety.

As shown in FIG. 1 and FIG. 3, the suspension structure further includes a mounting assembly 30, and the mounting assembly 30 is connected to an upper end of the frame assembly 10. It can be understood that when the suspension structure is assembled to the cabinet 40, and when the top plate is not arranged on the upper end of the cabinet body 40, it is necessary to provide the mounting assembly 30 on the upper end of the fixing plate 103 of the frame assembly 10. The left and right ends of the mounting assembly 30 are configured to fixedly connect to the cabinet body 40, and the bent body of the cover plate 107 is located between the mounting assembly 30 and the fixing plate 103. The mounting assembly 30 includes a rear buckle 301, a welding member 302, and a fixing member 303, wherein the rear buckle 301 and the fixing member 303 are connected to two ends of the welding member 302 respectively. The rear buckle 301 is made of the material including, but not limited to, plastic; and the rear buckle 301 and the fixing member 303 are both configured to fixedly connect the cabinet 40 so that the mounting assembly 30 can be additionally mounted to the upper end of the frame assembly 10 according to the actual assembly situation, so as to improve the applicability of the product.

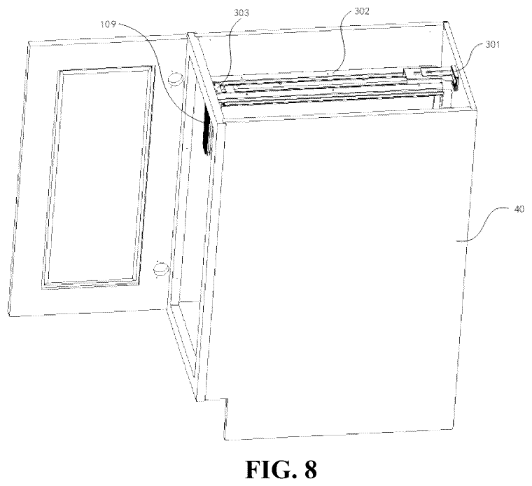

As shown in FIG. 8, in a second aspect, the present disclosure also provides a cookware tooling, including: a cabinet 40 provided with an accommodation cavity; and a suspension structure as described above, wherein the suspension structure is connected to the accommodation cavity.

Since the cookware tooling provided by the second aspect includes the suspension structure, the cookware tooling has all the technical effects of the suspension structure, which will not be repeated herein.

In all embodiments of the present disclosure, “large” and “small” are relative, “more” and “less” are relative, “up” and “down” are relative, and the expression of such relative terms is not repeated in the embodiment of the present disclosure.

It is understood that references throughout the specification to “in the embodiment”, “in the embodiment of the present disclosure” or “in an optional embodiment” imply that a particular structure, structure, or feature relative to the embodiment is included in at least one embodiment of the present disclosure. Therefore, “in the embodiment”, “in the embodiment of the present disclosure”, or “in an optional embodiment” appearing throughout the specification may not necessarily refer to the same embodiment. Additionally, these specific features, structures, or characteristics may be combined in one or multiple embodiments in any suitable method. It should also be appreciated by those skilled in the art that the embodiments described in the specification are all optional embodiments, and the actions and modules involved are not necessarily necessary for the present disclosure.

In the various embodiments of the present disclosure, it should be understood that the magnitude of the sequence number of the processes above does not imply an inevitable sequence of execution. The sequence of execution of each process shall be determined by its function and internal logic, and shall not constitute any limitation on the implementation process of the embodiments of the present disclosure.

The above is only the specific embodiment of the present disclosure, and the scope of protection of the present disclosure is not limited to this. Any change or replacement that can be easily thought of by any technical person familiar with the technical field within the technical scope disclosed by the present disclosure shall be covered within the protection scope of the present disclosure. Therefore, the scope of protection of the present disclosure shall be subject to the scope of protection of the claims.

1. A suspension structure, comprising:
a frame assembly, comprising a mounting frame and a fixing mechanism, wherein a mounting groove is arranged on a bottom of the mounting frame, and the fixing mechanism is connected to a top of the mounting frame; and
a suspension assembly, comprising a connection mechanism and a suspension member, wherein the connection mechanism is connected to the mounting groove, and the suspension member is connected to the connection mechanism to form a suspension body.

2. The suspension structure according to claim 1, wherein the connection mechanism comprises a first connector and a second connector, wherein the first connector is connected to the mounting groove; the second connector is connected to one side of the first connector away from the mounting frame; and one side of the second connector is connected to the suspension member.

3. The suspension structure according to claim 2, wherein the connection mechanism further comprises a first protrusion, wherein the first protrusion is connected to one side of the first connector away from the second connector so that a first gap is formed between the first connector and the mounting groove.

4. The suspension structure according to claim 2, wherein the connection mechanism further comprises a second protrusion, and the second protrusion is connected to a periphery of the first connector so that a second gap is formed between the first connector and the mounting groove.

5. The suspension structure according to claim 1, wherein the mounting frame comprises a first frame and a second frame, and a first extension member and a second extension member extend from a bottom of the first frame in a direction close to the suspension assembly; the first extension member and the second extension member are arranged at intervals; the connection mechanism is configured between the first extension member and the second extension member; the connection mechanism is connected to the first extension member and the second extension member respectively; and the second frame is connected to an inner cavity of the first frame.

6. The suspension structure according to claim 5, wherein the mounting frame further comprises a head sealing mechanism, and the head sealing mechanism is connected to one side of the first frame and the second frame.

7. The suspension structure according to claim 6, wherein the fixing mechanism comprises fixing plates and a guide rail, at least partial structure of the fixing plates is configured between the first frame and the second frame, and the guide rail is configured between the fixing plates and the second frame.

8. The suspension structure according to claim 7, wherein the fixing mechanism further comprises a supporting member, and the supporting member is connected between the two fixing plates.

9. The suspension structure according to claim 5, wherein the frame assembly further comprises a cover plate, the cover plate is provided with a bent body, the cover plate is configured at a bottom of the fixing mechanism, and the bent body bends relative to the fixing mechanism and extends to an upper end of the fixing mechanism.

10. The suspension structure according to claim 9, wherein one end of the bent body is provided with a first adaption part, and an upper end of the fixing mechanism is provided with a second adaption part, so that the first adaption part is adapted to the second adaption part after the cover plate is assembled to the fixing mechanism.

11. The suspension structure according to claim 10, wherein the frame assembly further comprises a sealing-cover assembly, and the sealing-cover assembly is configured on one side of the cover plate away from the first adaption part; the sealing-cover assembly comprises a first sealing cover and a second sealing cover, wherein at least partial structure of the first sealing cover is configured in an inner cavity of the cover plate and the partial structure is connected to the fixing mechanism; and the second sealing cover is connected to the first frame.

12. The suspension structure according to claim 11, wherein the suspension structure further comprises a mounting assembly, and the mounting assembly is connected to an upper end of the frame assembly.

13. A cookware tooling, comprising:
a cabinet, provided with an accommodation cavity; and
the suspension structure according to claim 1, wherein the suspension structure is connected to the accommodation cavity.

14. The cookware tooling according to claim 13, wherein the connection mechanism comprises a first connector and a second connector, wherein the first connector is connected to the mounting groove; the second connector is connected to one side of the first connector away from the mounting frame; and one side of the second connector is connected to the suspension member.

15. The cookware tooling according to claim 14, wherein the connection mechanism further comprises a first protrusion, wherein the first protrusion is connected to one side of the first connector away from the second connector so that a first gap is formed between the first connector and the mounting groove.

16. The cookware tooling according to claim 14, wherein the connection mechanism further comprises a second protrusion, and the second protrusion is connected to a periphery of the first connector so that a second gap is formed between the first connector and the mounting groove.

17. The cookware tooling according to claim 13, wherein the mounting frame comprises a first frame and a second frame, and a first extension member and a second extension member extend from a bottom of the first frame in a direction close to the suspension assembly; the first extension member and the second extension member are arranged at intervals; the connection mechanism is configured between the first extension member and the second extension member; the connection mechanism is connected to the first extension member and the second extension member respectively; and the second frame is connected to an inner cavity of the first frame.

18. The cookware tooling according to claim 17, wherein the mounting frame further comprises a head sealing mechanism, and the head sealing mechanism is connected to one side of the first frame and the second frame.

19. The cookware tooling according to claim 18, wherein the fixing mechanism comprises fixing plates and a guide rail, at least partial structure of the fixing plates is configured between the first frame and the second frame, and the guide rail is configured between the fixing plates and the second frame.

20. The cookware tooling according to claim 19, wherein the fixing mechanism further comprises a supporting member, and the supporting member is connected between the two fixing plates.
